(19) United States
(12) Patent Application Publication
(10) Pub. No.: US 2020/0404895 A1
(43) Pub. Date: Dec. 31, 2020

(54) THREADING DEVICE AND FISHING TOOL

(71) Applicant: Troy Wheelwright, Amesbury, MA (US)

(72) Inventor: Troy Wheelwright, Amesbury, MA (US)

(21) Appl. No.: 16/545,275

(22) PCT Filed: Feb. 28, 2018
(86) PCT No.: PCT/US2018/020131

§ 371 Date: Aug. 20, 2019

(51) Int. Cl. A01K 91/04

(52) U.S. Cl. CPC A01K 91/04

(57) ABSTRACT

A threading device and fishing tool for threading line and the like into and through a desired opening includes a needle and a needle holder. The needle includes an interconnection area for connection with a line. The needle is held in place in a holder by either permanent magnets or electromagnetic means. In use, the tip of the needle is first inserted in or through the desired area while the needle remains connected to the needle holder in the needle base area. The needle tip returns to the needle holder while next the needle base becomes separated from the needle base holder area allowing the needle and line to be inserted through an opening or into material. The threading device may be used independently or be part of a fishing tool which may include a knot tying portion, line clippers, line cutter, and fishhook threading assistance region.

### TECHNICAL FIELD

The present invention relates to fishing tools and threading devices and more particularly, relates to a device for threading line, yarn, thread and the like into and through a desired opening or location and for providing other fishing tool functions.

### BACKGROUND INFORMATION

Fishing poles, for example, are typically constructed from a generally rigid pole member to which is attached one or more “eyelets” through which fishing line must be threaded in order to utilize the fishing pole. In addition, there are other situations in which a line, yarn or the like must be threaded into or inserted through such as, for example, in the case of sewing garments or other textile materials and cut or tied into a knot.

To date, there has not been a convenient, reliable and efficient way to accomplish such tasks. Accordingly, what is needed is a threading device and fishing tool which is universal and allows the user to thread yarn or the like into and through a desired opening such as an eyelet of a fishing pole or into and through material such as cloth or textile and for performing other fishing related functions.

### SUMMARY

The present invention features a threading device which includes a needle having a thread, line or yarn engagement region configured to temporarily hold the line, thread or yarn on and connected to the needle in a manner that allows the line, thread or yarn to be pulled forward yet releasably detached from the needle when desired.

The needle is designed having a longitudinal axis with a tip proximate one end of the longitudinal axis and a base proximate an opposite end. The tip is typically sharp or pointed, although this is not a limitation of the present invention. The needle is releasably connected to a needle holder in 2 locations: the first location proximate the tip of the needle and the second location proximate the base of the needle. The releasable connection of the needle to the needle holding device proximate the tip and base of the needle allow the needle to be releasably disconnected from the needle holder first proximate the tip of the needle, following which the tip of the needle will releasably reconnect with the needle holder and next the base will be releasably disconnected and subsequently reconnected with the needle holder.

The needle includes surface features that are designed to engage with the features of the needle holder in a manner that allows the needle to releasably disconnect and reconnect from the top of needle holder but prevent it from being pushed rearward when force is applied during use. An optional feature proximate the base of the needle engages with a transverse slot at the rear of the needle holder to keep the needle from sliding forward when using the device to thread in a downward direction.

During use, the needle is releasably connected and disconnected sequentially first proximate its tip and next proximate its base allows the needle with attached line, thread or yarn to be inserted into an opening or a piece of textile in a sequential “see-saw” type of action or manner.

### BRIEF DESCRIPTION OF THE DRAWINGS

These and other features and advantages of the present invention will be better understood by reading the following detailed description, taken together with the drawings wherein:

FIG. 1 is a perspective view of a needle threading device in accordance with one embodiment of the present invention;

FIG. 2 is a side view of the needle threading device shown in FIG. 1 with the tip portion of the needle disengaged from the needle holder;

FIG. 3 is a perspective view of the needle threading device shown in FIG. 1 with the rear portion of the needle disengaged from the needle holder;

FIG. 4 is a perspective view of the needle holder in accordance with one embodiment of the present invention;

FIG. 5 is a perspective view of a needle holder in accordance with another embodiment of the present invention;

FIG. 6 is a top view of one embodiment of a needle according to the present invention;

FIG. 7 is a view of the bottom portion of a needle holder illustrating a cavity for holding one or more permanent magnets in accordance with one embodiment of the present invention;

FIG. 8 is a top perspective view of a needle holder incorporating electromagnetically operated clamps in accordance with another embodiment of the present invention;

FIG. 9 is a perspective view of the needle holder of FIG. 8 illustrating the front of the needle disengaged from the front electromagnetic clamps in the needle holder;

FIG. 10 is a perspective view of the needle holder FIG. 8 illustrating the rear of the needle disengaged from the rear electromagnetic clamps in the needle holder;

FIG. 11 is a perspective view of another embodiment of a needle in accordance with the teachings of the present invention;

FIGS. 12 and 13 are perspective views of yet another embodiment of a needle in accordance with the teachings of the present invention;

FIG. 14 is a perspective view of a further embodiment of a textile needle in accordance with the teachings of the present invention;

FIG. 15 is a perspective view of a needle holder designed to accommodate the needle shown in FIG. 14;

FIGS. 16-21 are drawings of another embodiment of the invention, namely, a fishing tool incorporating the threading device described in FIGS. 1-15 along with other fishing related tools; and

FIG. 22 is a drawing of yet another embodiment of the fishing tool of the present invention incorporation a line cutter.

### DETAILED DESCRIPTION OF THE PREFERRED EMBODIMENTS

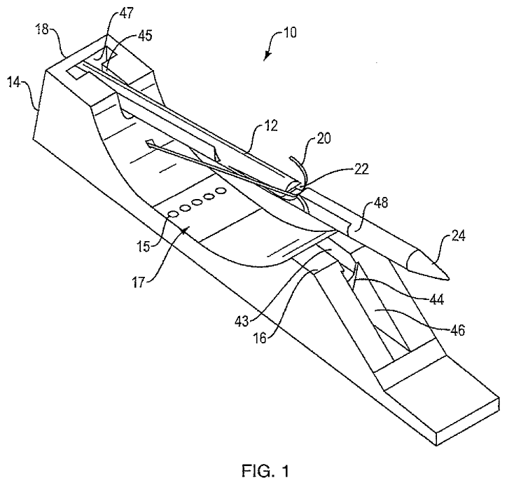

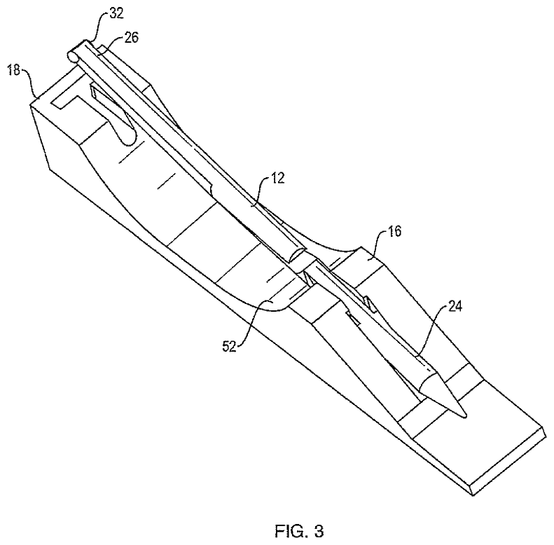

The present invention features a threading device and fishing tool 10, FIG. 1, comprising a needle 12 and a needle base or holder 14. In all embodiments, the needle holder 14 includes a first needle holding portion 16 proximate the front of the needle and a second needle holding portion 18 proximate the rear of the needle. The needle holding portions 16 and 18 preferably have longitudinally oriented channels 43 and 45 sized to easily accept the width and height of the needle. The channel 43 in the front holding portion 16 opens to a slightly wider opening 46. The transition 44 between the narrower channel 43 and the larger opening 46 in needle holding portion 16 makes a ridge 44 designed to secure the needle from sliding backwards during use particularly when the rear portion of the needle is raised as shown in FIG. 3 and as will be explained in greater detail below. The needle 12 contains magnets or preferably is made from ferromagnetic metal such as iron or certain types of steel that has magnetic properties.

The needle 12 is held in place in the needle holder 14 by means of one or more permanent magnets in the needle holder 14 or by an electromagnetic clamping mechanism in the needle holder 14 that can be energized and de-energized according with appropriate timing to allow use of the threading needle as will be explained below.

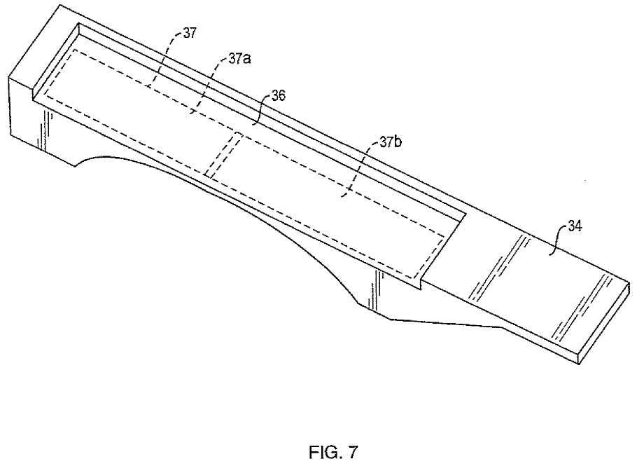

In one embodiment as shown in FIG. 7, the bottom region 34 of the needle holder 14 may include a recessed region 36 into which one or more permanent magnets (one long magnet 37 in the entire slot or alternatively 2 shorter magnets 37a and 37b in the front and rear of the slot) may be provided to hold the needle 12 in place.

The needle holder 14 includes, in addition to raised first and second needle holder portions 16 and 18, a central depressed region 17 which is preferably curved and may optionally include one or more rollers 15 which serve to move the holder 14 through the material or device through which a line 20 is to be threaded.

As shown in FIGS. 1-3, operation of the threading device 10 in accordance with the teachings of the present invention begins by first inserting a piece of line 20 into a slot, cut out or other area 22 of the needle. The line or string is what is to be threaded into another device. The tip 24 of the needle is disengaged from the front needle holder 16 and threaded through an object such as an eyelet on a fishing pole, a piece of textile or the like. As the tip 24 of the needle is disengaged from the needle holder 16 to be threaded into another device, the back end of the needle 26 and the protrusion 32 if provided remains securely held within channel 45 of needle holder 18 such that the rear wall 47 of channel 45 can be used to apply pressure to the back end 26 of the needle to force it through material or an eyelet.

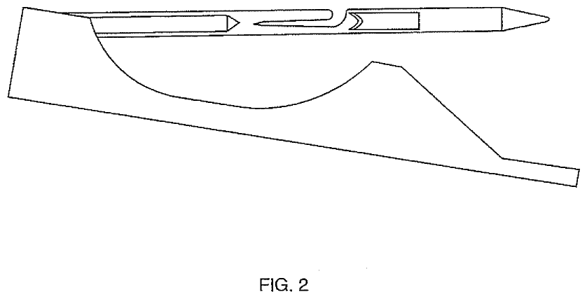

The same view of FIG. 1 is shown in cross-section in FIG. 2. Next, as shown in FIG. 3, the tip 24 of the needle is returned to the front needle holder 16 and subsequently the back end of the needle 26 is raised from the rear of needle holder portion 18 such that the eyelet or material can pass around the rear portion 26 of the needle 12 along with any rope or line 20 attached to the needle.

When the rear of the needle is raised, the front of the needle 24 is held in place in slot 43 of needle holder 16 by magnetic force. Additionally, the larger diameter 48 of the front of the needle makes contact with the ridge 44 at the front of the slot 43 of the needle holder 16 to prevent the needle from sliding backwards. This allows the user to pull the needle through the eyelet or material while the rear of the needle is elevated. This “seesaw” motion is repeated for every threading action desired. The holder 14 facilitates gripping of the needle and threading it while the permanent or electromagnets located in the front and rear needle holder 16, 18 securely holds the needle in place when in use.

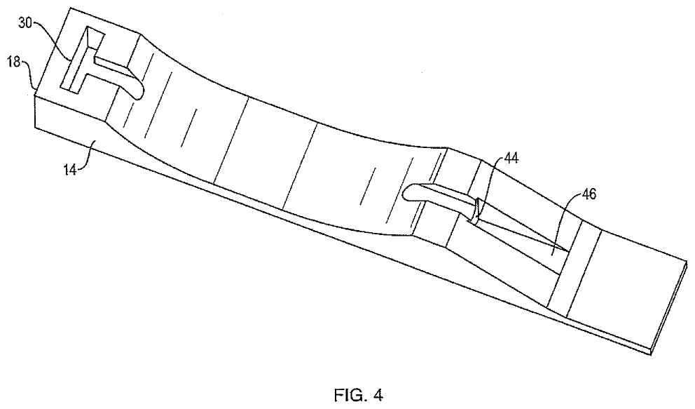

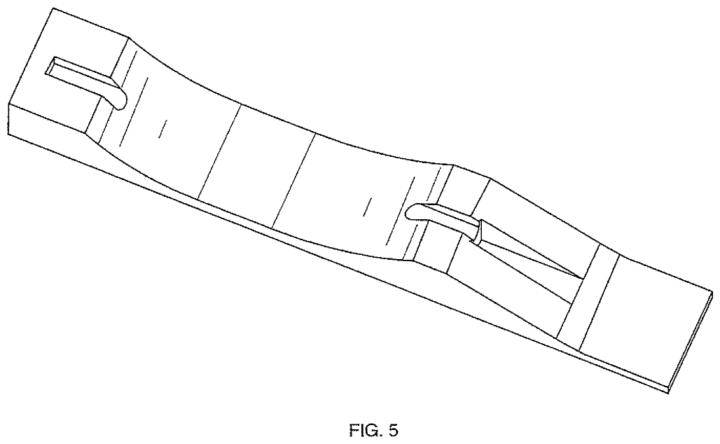

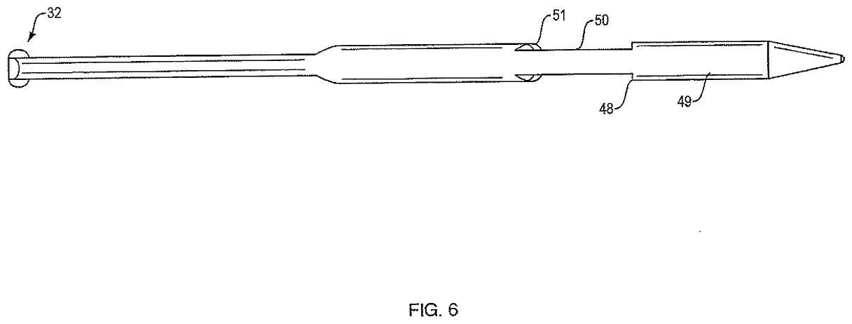

In a preferred embodiment, the needle holder 14, FIG. 4, includes a transverse slot 30 in the rear needle holding portion 18. The transverse slot 30 allows the back end of the needle 26 to rest against the slot so that the needle may be “pushed” forward into or through any material that is desired to be threaded with the line or yarn. The transfer slot 30 aligns with feature 32 (if provided) at the back end 26 of the needle 12. This feature, if provided, serves to keep the needle from sliding forward in the holder 14 when using the device in a downward direction. This is a preferred embodiment, however, and not a limitation of the present invention as the needle holder may be made without such a slot as shown in FIG. 5 and the needle 12 may be provided without the feature 32. If provided, the end of the needle need not have a tremendously long T portion but may be simply small protrusions 32 on each side of the end of the needle as shown in FIGS. 3 and 6.

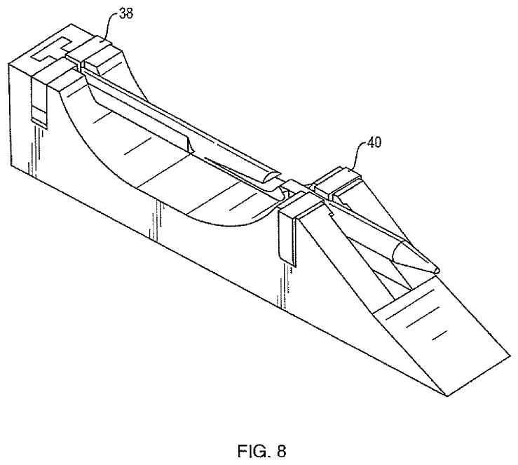

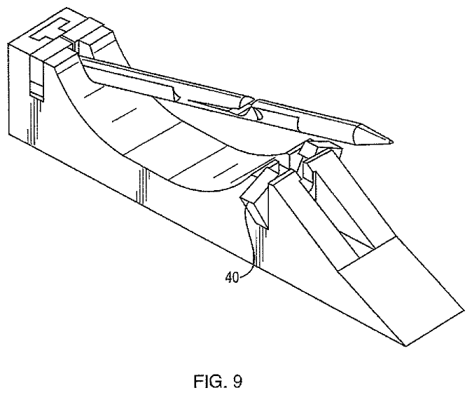

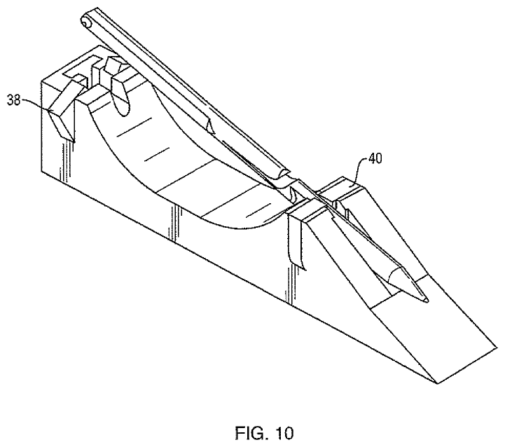

Alternatively, as previously discussed, one or more electromagnetic clamps 38, 40, FIG. 8 may be utilized in place of permanent magnets. In this case, the electromagnets would be sequenced and timed such that first the front magnets 40 would be caused to turn off allowing the clamps to open and the front of the needle or threading rod to swing away from the holder as shown in FIG. 9. As the front of the needle/rod is pushed through the hole, the rear electromagnets 38 remains closed. Subsequently as shown in FIG. 10, the front electromagnet reengages after the front of the needle has passed through the hole forcing a re-coupling of the front end of the needle and the holder and reengaging the front clamps. After re-securing the front of the needle, the rear electromagnet disengages allowing the rear clamps to open and the back of the needle to swing away from the holder so that the needle and attached line or cable can be pulled through. Once clear of the threading hole, the rear electromagnet reengages and forces a re-coupling of the back portion of the needle with the holder. The sequence can continue as desired. Clamps are shown but are not limiting as a sliding pin mechanism or other similar mechanism known or obvious to those skilled in the art is contemplated by this invention.

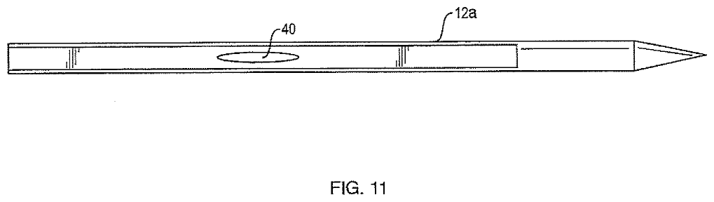

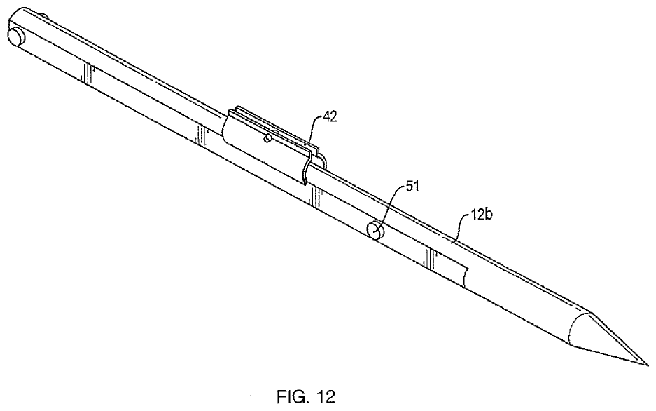

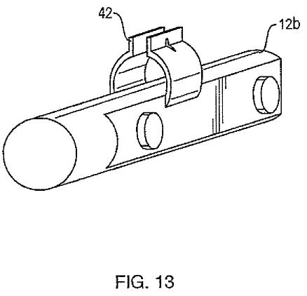

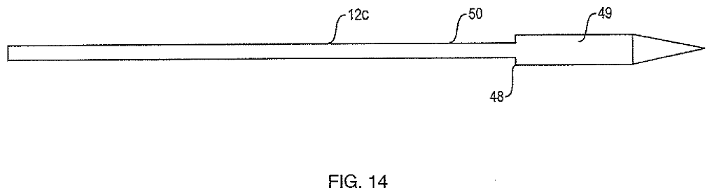

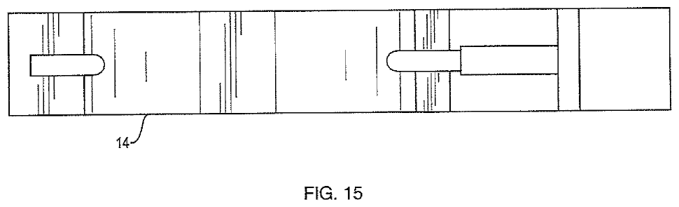

The needle 12a, FIG. 11, may take on different forms, shapes and methods of interconnecting with a thread or line. Although one line interconnection method is shown in FIG. 1, an additional method is shown in FIG. 11 which includes providing a hole 40 in needle 12a. In another embodiment shown in FIG. 12, the needle 12b may include a clamping mechanism 42 which can be utilized to clamp a wire, cable or line onto the needle 12b. This is shown in greater detail in FIG. 13. In yet another embodiment shown in FIG. 14, the needle 12c may be a textile type needle without any rear portion or protrusion 32 to mate with a rear portion of the needle holder 14, as shown in FIGS. 5 and 15. Other than the possibility of a protrusion 32 on the needle, the needle includes no protrusions between its front end and its back end. The protrusion 32, if provided, provides the advantage of abutting against the rear wall 47 of channel 45 and can be used to apply pressure to the back end 26 of the needle.

The needle has a larger diameter area at the tip 49 as shown in FIGS. 6 and 14. A narrower section 50 is directly posterior to the larger diameter tip as shown in FIGS. 6 and 14. The narrow section can extend rearward the length of the needle as shown in FIG. 14, or be intermittent as shown in FIG. 6. The transition between the narrow section 50 and the larger diameter tip 49 form a ridge or shelf 48 that contacts area 44 of the needle holder portion 16 and prevents the needle from sliding backwards during use. The narrow sections 50 form preferably flat surfaces on either side of the needle. When the narrow section 50 of the needle is engaged with the channels 43 and 45 of the needle holder, the flat sections keep the needle from rotating within the channel. The relatively tight tolerance between the narrow section 50 of the needle and the inside channel walls 43 and 45 of the holder, also help to keep the needle oriented in line with the channels as the needle “see-saws” in and out of the holder during use.

Optionally, another feature 51 shown in FIGS. 6 and 12 demonstrate an enlarged area just posterior to the narrow section 50 at the front of the needle. This enlarged area is designed to keep the needle from sliding forward when the back of the needle exits from channel 45 of the needle holder portion 18. This would be most useful when using the device to thread in a downward direction, as the enlarged area 51 comes in contact with the back side 52 of needle holder portion 16 preventing forward movement of the needle.

Accordingly, the present invention provides, in one embodiment, a stand-alone novel needle mechanism allowing a wire, line, thread, yarn or the like to be easily and quickly threaded through islets, cloth material or the like as desired.

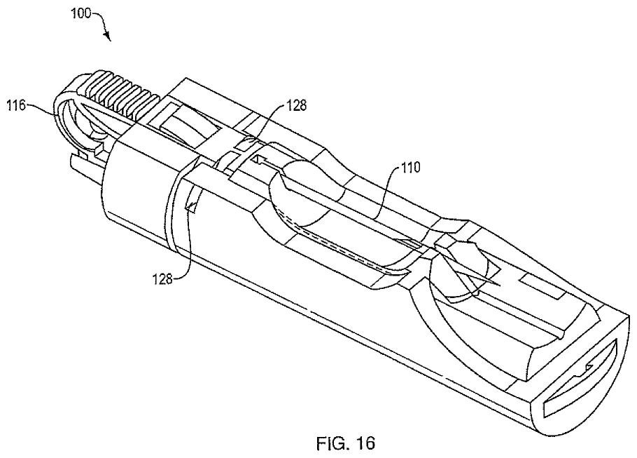

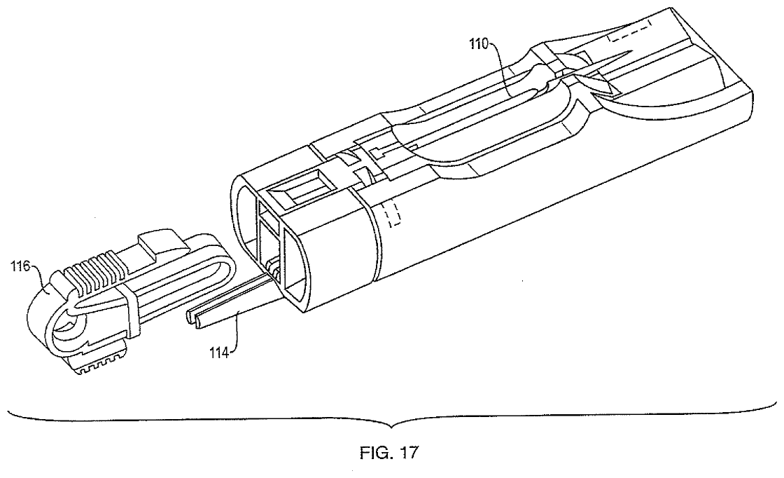

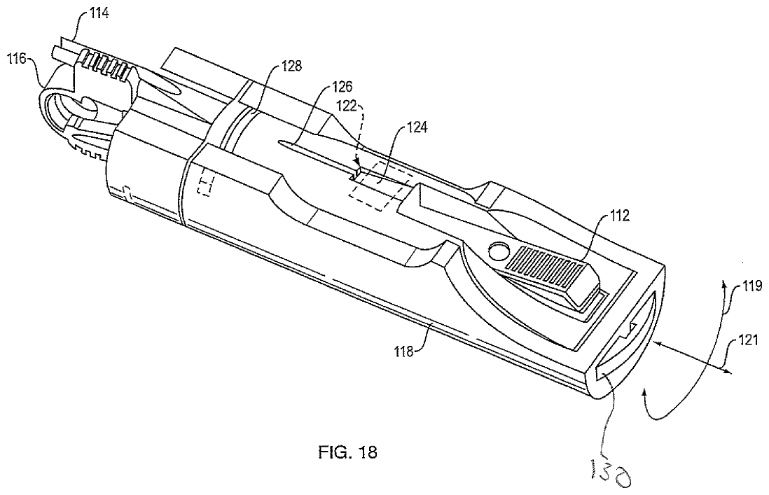

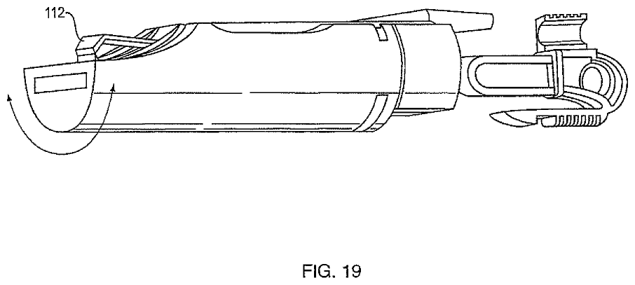

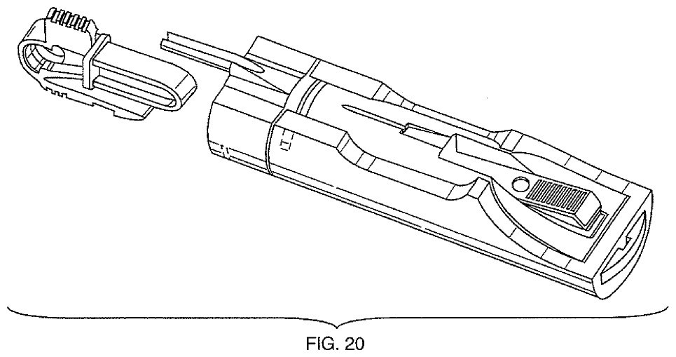

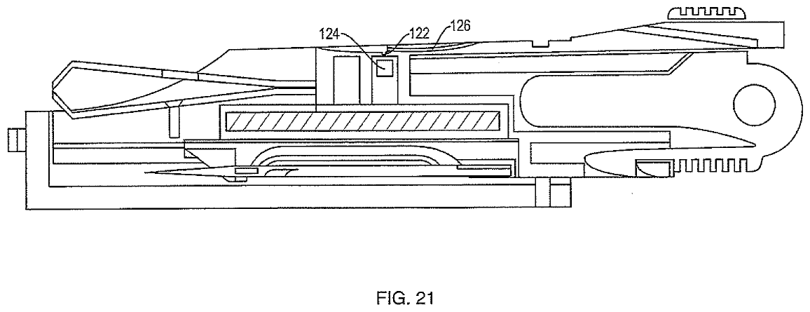

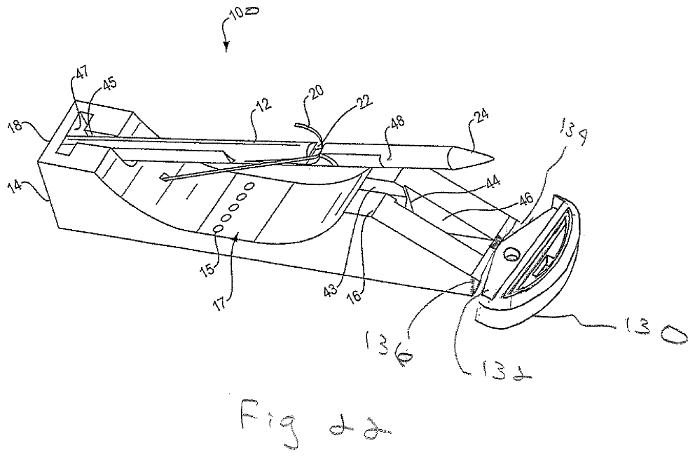

In another embodiment contemplated by the present invention, the novel needle mechanism may be incorporated into another device such as a fishing tool 100, FIGS. 16-22, which includes, in addition to the needle threading device 110, fishing line clippers 112 FIG. 17 (see also FIG. 18), a knot tying tool 114 (see also FIG. 18), a removable/releasable clip 116 (see also FIGS. 17 and 18), a line cutter 130 (see all FIG. 22), a rotatable cover 118 designed to rotate in the direction of arrows 119 FIG. 18, about the longitudinal axis 121 of the tool and selectively expose the clippers 112 and knot tying tool 114 as shown for example in FIG. 18 or the threading needle as shown in FIGS. 16 and 17 for example. The fishing tool 100 also includes a slot 128, FIGS. 16 and 18 into which several protrusions from the rotatable cover 130 engage allowing the cover 118 to rotate about the longitudinal axis of the fishing tool.

The novel fishing tool 100 of the present invention also includes a fishhook threading device 122, FIG. 18 which includes a magnet 124 shown in dashed lines located beneath the plastic structure and the fishhook threading region 122. The magnet 124 allows the fishhook to stand vertically up right and aligns the eyelet of the fishing hook with a sloping trough 126 in the plastic allowing the fishing line 128 to be inserted into the trough and automatically feed into the fishing hook eyelet (not shown but well known in the art) and out the other side ready to be tied.

In another embodiment, the fishing tool 100, FIG. 22, may include a line cutter 130 disposed on either end of the fishing tool 100. The line cutter included a blade 132 angled outward to the outside of the fishing tool 100. The fishing line to be cut is simply slid into the opening or slot 134 and slid between the cutting blade 132 and the fishing tool surface 136 Accordingly, the above embodiment provides a novel fishing tool including, in addition to the needle mechanism, additional functionalities desired by those engaged in the sport of fishing including, for example, line clippers, a knot tying region and a fishhook eyelet threading region.

Modifications and substitutions by one of ordinary skill in the art are considered to be within the scope of the present invention, which is not to be limited except by the allowed claims and their legal equivalents.

The invention claimed is:

1. A threading device for threading line, yarn, thread and the like into and/or through a desired opening or location, said device comprising:
a needle, said needle including a line interconnection area configured for connecting said needle with said line, yarn, thread or the like;
a needle holder, said needle holder including at least first and second needle interconnection regions, said first needle interconnection region disposed proximate a front region of said needle holder and configured for interconnecting with a front end of said needle, said second needle interconnection region disposed proximate a back region of said needle holder and configured for interconnecting with a back end of said needle, wherein said first and second needle interconnection regions include a slot provided in said needle holder;
said needle holder further including a needle retainer; and
wherein said needle holder and said needle retainer are configured for selectively first allowing said front end of said needle to disengage from said needle holder proximate said front end of said needle holder until said needle and accompanying line is threaded through an object or device, and wherein said needle holder and said needle retainer are is further configured for allowing said first end of said needle to reengage with said front end of said needle holder and subsequently allow said back portion of said needle to disengage from said needle holder proximate said back and of said needle holder until said needle and accompanying line is threaded through an object or device, wherein said needle holder and said needle retainer are further configured for allowing said second end of said needle to reengage with said back end of said needle holder; and
wherein said needle and needle holder are configured for continuing the alternating pattern of first disengage and from 1 of said front or back ends of said needle holder following which once the front or back end of the needle re-engages with the corresponding portion of the needle holder, allowing the other portion of the needle holder to disengage and subsequently reengage.

2. A fishing tool including the threading device of claim 1.

3. The fishing tool of claim 2, wherein said fishing tool further includes one or more of a detachable clip, fishing line clippers or cutters, a knot tying assistance region, a fishhook eyelet threading assistance region and a rotatable cover.

4. The threading device of claim 1 wherein said needle holder is selected from the group of needle holders consisting of permanent magnets and a controllable electromagnetic clamp.

5. A fishing tool body comprising:
a line threading device comprising:
a needle, said needle including a line interconnection area configured for connecting said needle with a fishing line;
a needle holder, said needle holder including at least first and second needle interconnection regions, said first needle interconnection region disposed proximate a front region of said needle holder and configured for interconnecting with a front end of said needle, said second needle interconnection region disposed proximate a back region of said needle holder and configured for interconnecting with a back end of said needle, wherein said first and second needle interconnection regions include a slot provided in said needle holder;
said needle holder further including a needle retainer;
wherein said needle retainer is configured for selectively first allowing said front end of said needle to disengage from said needle holder proximate said front end of said needle holder until said needle and accompanying line is threaded through an object or device, and wherein said needle holding means is further configured for allowing said first end of said needle to reengage with said front end of said needle holder and subsequently allow said back portion of said needle to disengage from said needle holder proximate said back and of said needle holder until said needle and accompanying line is threaded through an object or device, wherein said needle holding means is further configured for allowing said second end of said needle to reengage with said back end of said needle holder; and
wherein said needle and needle holder are configured for continuing the alternating pattern of first disengaging from one of said front or back ends of said needle holder following which once the front or back end of the needle re-engages with the corresponding portion of the needle holder, allowing the other portion of the needle holder to disengage and subsequently reengage in an alternating pattern; and
at least one fishing tool coupled to said fishing tool body, said at least one fishing tool selected from the group of fishing tools consisting of a fishing hook threader, a fishing line cutter, a fishing line clipper, a line knot tying tool, a removable/releasable clip and a rotatable cover.

6. The fishing tool of claim 5 wherein said needle retainer is selected from the group of needle retainers consisting of permanent magnets and a controllable electromagnetic clamp.
